(19) United States
(12) Patent Application Publication
(10) Pub. No.: US 2006/0146132 A1
(43) Pub. Date: Jul. 6, 2006

(54) Video system having multiple video cameras for capturing events

(76) Inventor: Hy Mayerson, Birchrunville, PA (US)

Correspondence Address: BLANK ROME LLP, 600 NEW HAMPSHIRE AVENUE, N.W., WASHINGTON, DC, 20037, US

(21) Appl. No.: 11/028,527

(22) Filed: Jan. 5, 2005

(51) Int. Cl. H04N 7/18; H04N 9/47

(52) U.S. Cl. 348/143

(57) ABSTRACT

A video monitoring system has multiple video cameras, each one associated with a respective recorder and video monitor. The video cameras are serially aligned along a field of action so that the field of view for each camera is interlaced with the field of view of the adjacent camera(s). Each camera captures images for a portion of the field of action, which is displayed on the respective monitor. The monitors are positioned side-by-side so that a continuous image is displayed on the monitors of the entire field of action.

### FIELD OF THE INVENTION

The present invention relates to a video system for remotely viewing and/or recording of an event. More particularly, the video system according to the invention is directed to a system which creates and permits a wide view of a sporting events, such as a football game, a horse race, basketball game, skiing race, a ballet or the like, so that the spectator can simultaneously view a wide field of action that is larger than that of a single camera alone, live or in replay. Or the spectator can choose to look at a part of the game or action that would otherwise not be available to see.

### BACKGROUND OF THE INVENTION

When visiting public locations or public events, such as sporting events, horse races, ballets, musicals, or the like, it is often desirable to view and/or record the occasion through use of a video system. Normally, a single camera covers an isolated area of the event by following an object, such as an athlete, a football, a horse, a ballerina, an actor, or the like, and displaying a single camera's view through a single video display monitor. Because of the limited field of view of the camera, other actions or participants within the field of action, but outside the camera's field of view, cannot be followed by the viewer as they are viewable only on a single monitor showing only a single camera's point of view at that instant.

During an event having a large field of action, the camera typically follows the main action (or a single action or a single location), while leaving other peripheral actions uncovered. This is particularly true, for example, during a football game where the camera mainly follows the ball while leaving other interesting or important actions elsewhere uncovered. If several different cameras are covering an event, the cameras may offer different views from different vantage points which may later show action from two places. But, there is no system which simultaneously shows live, for instance, what the quarterback is doing at his 45 yard line, what the line backer is doing at his 45 yard line, and what is happening downfield at the 35 yard line.

Further, the viewer has no control of what is covered and cannot select the desired action to watch. For example, it is not possible for a viewer to follow the actions of a particular receiver or linebacker on the football field (field of action) because he is often out of the field of view of the camera. Although a football game is taken as an example, other public events, such as other sporting events, horse races, ballets, ice skating, musicals, or the like, suffers from the same drawback.

Therefore, there remains a need for a video system that can capture a large field of action all at once to allow the view to select what and who to watch during a complex, action packed event.

### SUMMARY OF THE INVENTION

It is an object of the present invention to provide a video system for viewing and/or recording an event, either live, by playback, at the event, or remote from the event. More particularly, the video system according to the invention provides to a system which permits viewers to simultaneously watch a wide field of action that is larger, wider and broader than that of a single camera or single monitor alone. When the present system is displayed to a large number of viewers, each viewer can follow his/her selected objects (an athlete, a horse, a ballerina, an actor, or the like) or actions within a field of action and is not subjected to the limited view of the program director's choice of a single camera/monitor combination.

The video system of the present invention contains a series of cameras having interlaced field of views throughout a field of action. Each camera is connected to a video monitor (which can be a projector) which, when aligned side by side, together show a wide, panoramic field of view and flow of the field of action.

The invention also allows in the recorded view, to stop the action and see two or more different areas of the event at once. For example, at a football game, five cameras are lined up 10 yards apart to show only the 10 yards in front of each camera. As a football player moves downfield (or a dancer across the stage or an ice skater across the rink) from the spectators left to the spectators right, the moving player moves in real time from camera to camera and simultaneously from synchronized interlaced monitor to monitor or projected image to projected image. One may stop the replay and see what the quarterback is doing or which direction he is looking, one can see what the linebacker is doing, one can see where the end is downfield and how, if at all, he is cutting.

### BRIEF DESCRIPTION OF THE DRAWINGS

FIG. 1 shows the preferred embodiment of the present invention implemented at a racetrack.

### DETAILED DESCRIPTION OF THE PREFERRED EMBODIMENT

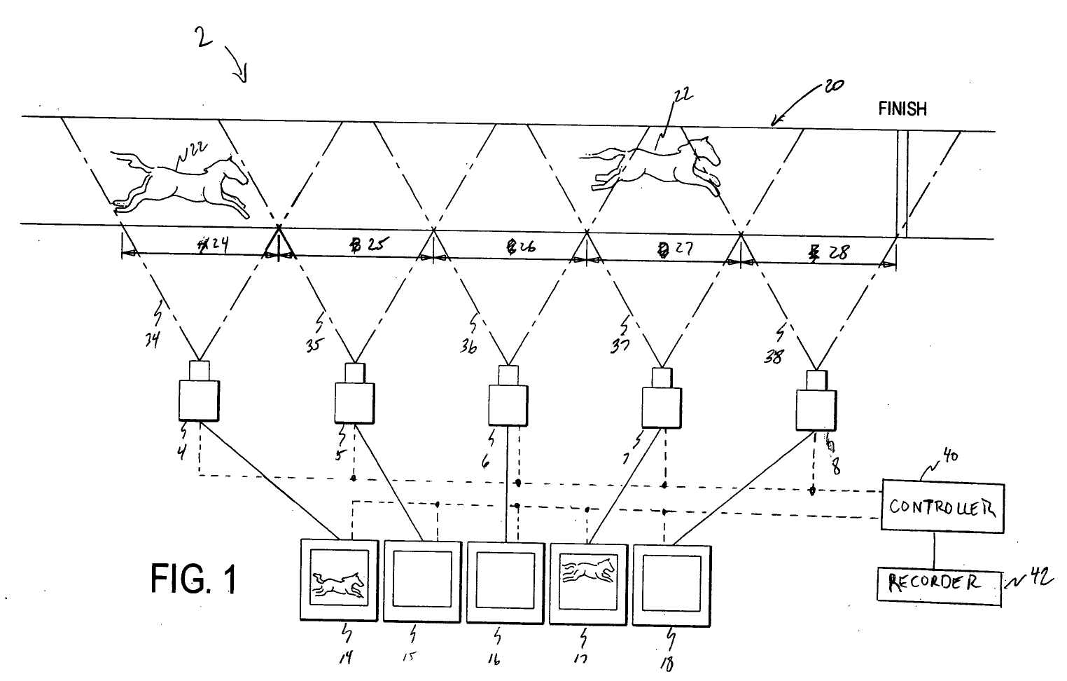

Referring to FIG. 1, the video system 2 of the present invention contains a plurality of cameras (and optionally also recorders) 4, 5, 6, 7, 8 and a plurality of video monitors (or projectors) 14, 15, 16, 17, 18. Each video monitor 14-18 is associated with a camera 4-8, and displays the video captured by that camera. For example, as illustrated in FIG. 1, a first video monitor 14 displays the video feed from the first video camera 14, a second video monitor 15 displays the video feed from the second video camera 15, the third video monitor 16 displays the video feed from the third camera 6, the fourth video monitor 17 displays the video feed from the fourth camera 7, and the fifth video monitor 18 displays the video feed from the fifth camera 8.

The cameras 4-8 are positioned to capture images from a field of action 20. The video feed from each of the cameras (and recorders) 4-8 is transferred via electrical cables (or wirelessly) to its respective monitors 14-18 for display. The cables can directly connect each camera 4-8 to its respective monitor 14-18, or alternatively can be routed through an optional local server or controller 40. The cameras 4-8 and monitors 14-18 can be connected in parallel to the local controller 40 (as shown by the dashed lines in the figure), or can be connected serially to the controller 40. The images can also be synched and recorded either at the cameras 4-8, or the cameras can be connected to synched video recorder(s), such as a tape or a DVD recorder, to record the synchronized interlaced images. The recorders can be located at the cameras 4-8, or a single recorder 42 can be provided at the local controller or server 40.

The system is especially advantageous when used to display the field of action 20 of a sporting event. In the embodiment of FIG. 1, the finish line portion of a horse race is shown. One or more objects 22 may be within the field of action 20. Each camera 4-8 is aligned so that its field of view 34, 35, 36, 37, 38 captures a respective subsection 24, 25, 26, 27, 28 of the race. The cameras 4-8 are aligned so that its field of view 34-38 is interlaced with one another, such that the action passes smoothly from one camera and monitor to the next adjacent camera and monitor to provide a continuous coverage of action on the field 20. In the embodiment shown, the fields of view 34-38 diverge such that they substantially overlap at the far end of the racetrack. In practice, however, the cameras 4-8 are preferably positioned at a distance from the field of action 20 so that the fields of view 34-38 do not diverge to the extent shown in the illustration. Accordingly, the overlap between fields of view 34-38 is minimized and any overlap on the monitors 14-18 is not perceptible to any significant degree.

The video monitors 14-18 are positioned side-by-side with one another in the same sequence of their corresponding cameras 4-8. In this manner, the monitors 14-18 offer a continuous, interlaced, panoramic view of the field of action 20. Because the field of action 20 is larger than the field of view for each of the individual cameras, it is impossible to provide suitable coverage of the entire field of action with a single camera. However, the plurality of cameras 4-8 being interlaced together are able to capture the entire field of action, and those images displayed on the plurality of aligned monitors 14-18. Though the embodiment shows that the cameras are aligned to capture the event from one side, the cameras could be positioned at more than one side of the event, or even at all four sides of the event, with each side having its own plurality of cameras.

Although five cameras are shown, any number of cameras arranged to capture interlaced fields of view are appropriate for the present invention. For purposes of illustration, the field of action 20 in FIG. 1 is the final 200 feet of a horse race, and each section 24-28 is 40 feet in length. The cameras 4-8 occupy field of views 34-38, respectively. The field of views are directly adjacent to one another so that, for instance, the field of view for camera 4 ends where the field of view for camera 5 begins, and the field of view for camera 5 ends where the field of view for camera 6 begins. Thus, for instance, as the horse 22 leaves the field of view 34 of the first camera 4, it is picked up by the second camera 5, and as it leaves the field of view 35 of the second camera 5, it is picked up by the third camera 6.

Continuing with the example, the monitors 14-18 are placed adjacent to one another in the same order as their respective cameras so that the viewer can see the entire last 200 feet of the horse race. The viewer sees the horse 22 pass from one monitor 14 to the next monitor 15 without any break in the action. This is particularly advantageous because, when there are many viewers, each viewer of the horse race can follow a favorite horse as it comes into the last 200 feet of the finish line.

The monitors 14-18 are preferably television-type monitors and are positioned sufficiently close to one another so that the viewer can follow the action as it moves or flows from one monitor to the next. The actual distance between monitors (or projectors) may vary (from no distance between them, to several inches or feet or more) depending on the size of the taste of the program director, the size of the monitors, and the type of event being viewed. However, the monitors are preferably positioned as close as possible to one another, and most preferably touching. In addition, the monitors can be in the form of projectors that project an image onto a screen or the like. The images from the various projectors are projected onto a single screen, such that the projected images are preferably immediately adjacent one another, touching, or overlapping. Of course, multiple projection screens can also be utilized.

Although, each of the cameras have been described as having a field of view 34-38 of 40 feet, the field of view of the cameras can be the same or different and can be more or less than 40 feet as a function of the camera's placement, design and construction. For example, if a camera is positioned to have a field of view of 50 feet, then only four cameras would be required to cover the last 200 feet of the horse race. An advantage of the present invention is that it can be implemented using existing technology and available equipment in a way which presents few construction difficulties.

The system also provides for enhanced replay of the event. A local computer or controller 40 can optionally be connected to one or more of the cameras 4-8, so that the cameras 4-8 can be controlled to playback the action. The controller can be in addition to the local server, or integrated with the local server. The controller can control each camera 4-8 individually, permitting the viewer to watch action at different areas from the field of action 20 (such as at different parts of a football field). The cameras can play back action that occurs at a same time, or at different times (such as two different fumbles that occur at different times of a game). The controller 40 can also control all of the cameras 4-8 collectively, to provide synchronized playback of the action, and the controller can also control the recorder 42 located either at the controller 40 (or recorders located at the cameras 4-8) to perform any and/or all of the camera functions.

In addition, the cameras 4-8 can be mounted on a single (or separate) trolleys that move the cameras 4-8 to follow the action on the field of action 20. The trolleys can be controlled at the local controller.

Although, for illustrative purposes, the above description is presented in the context of a horse race, it will be recognized that the present invention could be equally well utilized at other events such as a sporting events, ballets, musicals, or the like. In addition, though multiple monitors are used in the preferred embodiment to increase the field of view for the event, the images from the different cameras can be combined onto a single monitor sufficiently large to accommodate the multiple images in a side-by-side manner. Further, it should be recognized that the system may be integrated into existing systems that broadcast events so that, for instance, the monitors can be at a location that is far remote (such as in another town or city) from the cameras. The cameras can also pick up sound, and the sound from one or more of the cameras may be the one(s) that are used at the monitor(s).

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A monitoring system comprising:
a plurality of video cameras arranged serially along a field of action such that the field of vision of one camera is interlaced with the field of vision of one or more adjacent cameras, each of said plurality of video cameras capturing an image; and
a plurality of monitors, each monitor in communication with one of said plurality of video cameras to receive the image captured by the one of said plurality of video cameras, said plurality of monitors arranged side by side to provide an interlaced view of the field of action.

2. The system of claim 1, further comprising a recording system for recording the images captured by the plurality of cameras.

3. The system of claim 2, wherein the recording system comprises at least one video recorder.

4. The system of claim 2, wherein the recording system comprises at least one video recorder associated with one of said plurality of video cameras.

5. The system of claim 2, wherein the recorded images are played back on said plurality of monitors.

6. The system of claim 1, wherein said plurality of monitors comprise a plurality of projection monitors that project images.

7. A method for viewing a field of action comprising the steps of:
providing a plurality of video cameras arranged serially along the field of action such that the field of vision of one camera is interlaced with the field of visions of its adjacent cameras;
providing a plurality of monitors, each monitor electronically communicates with one of the plurality of video cameras; and
arranging the monitors side by side such that an interlaced, panoramic view of the field of action is produced from the plurality of monitors.

8. The method of claim 7, further comprising the step of providing a recording system for recording images from the plurality of cameras.

9. The method of claim 8, wherein the recording system comprises at least one DVD recorder.

10. The method of claim 8, wherein the recording system comprises at least one video tape recorder.

11. The method of claim 8, further comprising the step of playing back the recoreded images on the plurality of monitors.

12. A system comprising:
a plurality of cameras arranged serially along a field of action such that the field of vision of one camera is interlaced with the field of vision of one or more adjacent cameras, each of said plurality of cameras capturing an image; and,
a display system having display portions adjacent to one another, said display system displaying each of the captured images in a respective display portion.

13. The system of claim 12, further comprising a controller connected to said plurality of cameras and said display system, said controller receiving the images captured by each of said plurality of cameras and transmitting each of the received images to said display system for display at one of the display portions.

14. The system of claim 12, wherein said display system comprises a plurality of monitors, each monitor having a display portion.

15. The system of claim 12, wherein said controller controls the operation of said plurality of cameras to provide synchronous operation of said plurality of cameras.

16. The system of claim 12, wherein said controller selectively controls the operation of said plurality of cameras.

17. The system of claim 12, further comprising a recorder associated with said controller to record an image captured by at least one of said plurality of cameras.

18. The system of claim 17, wherein the recorded images are played back on said display system.

19. The system of claim 12, wherein said display system comprises a plurality of projection monitors that project images.

20. The system of claim 12, further comprising a plurality of recorders each associated with one of said plurality of cameras, and a controller connected to said plurality of cameras, said plurality of recorders, and said display system, said controller controlling operation of each of said plurality of cameras, said plurality of recorders, and said display system.
